(19) United States
(12) Patent Application Publication
(10) Pub. No.: US 2011/0099905 A1
(43) Pub. Date: May 5, 2011

(54) Water feature integrated with a movable barrier such as a gate or window

(76) Inventor: Susannah E. Rake, Santa Barbara, CA (US)

(21) Appl. No.: 12/589,957

(22) Filed: Oct. 30, 2009

(51) Int. Cl. E06B 7/00; B05B 17/08; F21S 8/00

(52) U.S. Cl. 49/70; 239/17; 239/18; 446/267

(57) ABSTRACT

An aesthetic movable barrier such as a window or gate, with an integrated liquid feature. The barrier includes a liquid supply, a power source, pump and plumbing to provide an aesthetic liquid flow across a visible surface, preferably textured, of the barrier. The liquid feature is preferably recirculating.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention is an aesthetic movable barrier, including openable gates and windows with an integrated liquid flow feature.

Water walls, both opaque and transparent, are becoming quite popular for their visually aesthetic and soothing properties. Many large fixed examples of such water features exist and are known in the art.

The availability of small efficient pumps, solar cells and associated battery/charger systems along with a wealth of choices in plumbing options, such as highly flexible plastic hoses and the like, have led to the proliferation of water flow features in relatively small scale, including table top units. Many of these recirculate the liquid and draw little power to minimize waste and resource usage. To date, even the smallest and most efficient water features are confined to fixed structures. It would be highly desirable to create the positive effects of fixed water walls and the like in movable structures such as openable gates and windows.

### BRIEF SUMMARY OF THE INVENTION

The invention is an aesthetic movable barrier with at least one motion degree of freedom, including a hinged or a sliding motion of the barrier, a liquid source, a pump, a power source for the pump, and a plumbing system. The liquid from the source is directed from a first portion of the plumbing system to flow across a portion of a face of the barrier and then captured by a second portion of the plumbing system for transport by pumping through a third portion of the plumbing system to the first portion, thereby providing an esthetic flow across the face of the movable barrier.

In some embodiments, the liquid source may be one or more of a fillable reservoir or a connection by flexible hose to an external supply.

In other embodiments, the power source may be one or more of a connection to an external source, an integrated solar power system or a battery system.

In other embodiments, lighting may be added. In a particular embodiment OLED's may be used as part of a textured surface in the flow

### BRIEF DESCRIPTION OF THE DRAWINGS

The invention will be better understood by referring to the following figures;

FIG. 1 depicts a hinged embodiment of the invention

FIG. 2 depicts a sliding embodiment of the invention

FIG. 3 depicts options for the liquid source

FIG. 4 depicts options for the power source

### DETAILED DESCRIPTION OF THE INVENTION

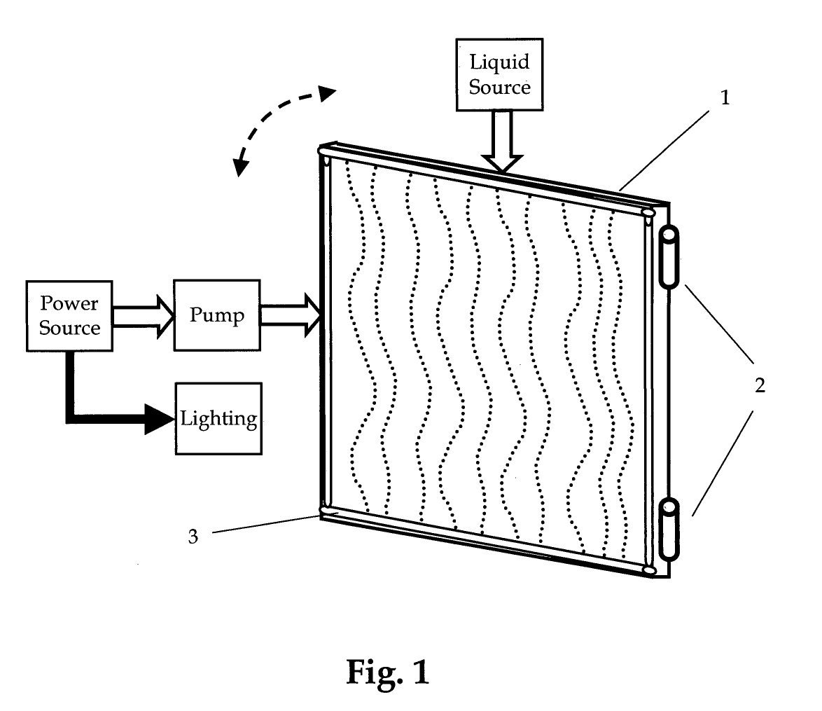

FIG. 1 illustrates one embodiment of the invention. A barrier object 1 is movable in this case by being hinged 2. One surface of the barrier is plumbed 3 in such a manner as to provide for the delivery and capture of a flow of liquid across a surface of barrier 1. A liquid source provides liquid to a first portion of plumbing 3 which distributes the liquid in a flow pattern. A second portion of plumbing 3 captures the liquid from which it is pumped through a third plumbing portion back to the first portion of the plumbing to provide a recirculating flow across the surface of barrier 1. The pump requires a power source. Preferably the flow surface, which may be on either or both sides of the barrier is textured to provide a more esthetic flow. It is also possible to include lighting in the barrier, which may be any combination of external or internal to the flow surface. A particularly pleasing lighting implementation uses Organic LED's (OLED's), an array of which may be used to form the textured surface.

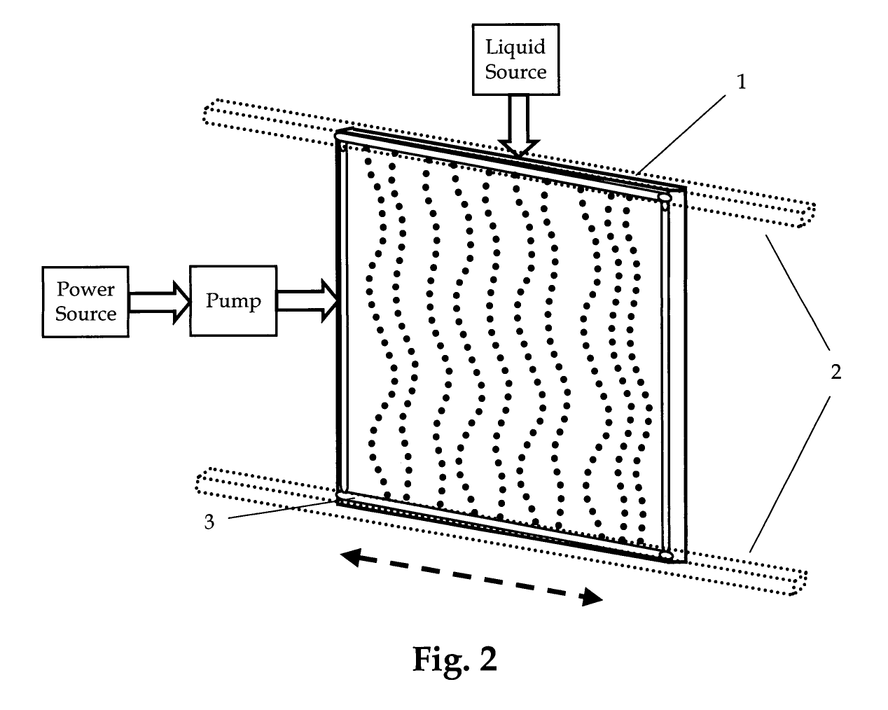

FIG. 2 depicts an alternative arrangement where the barrier is a sliding object rather than hinged. Other openable barriers, such as folding doors/windows, cantilever doors and so on could also carry the components for a water flow feature. In all embodiments it is understood that the flow area may be open to the air or enclosed by a cover, such as plastic or glass sheeting. The invention is compatible with a variety of operating modes of the movable object, manual, automatic, powered, un-powered or others.

Because of the options available for plumbing, pumping and power it is practical to add necessary components to a movable barrier with undue compromise in space and functionality. The inventor contemplates that a particularly attractive embodiment is that of entry gates such as used for driveways. Such gates, particularly those used for fine homes and other establishments placing a premium on esthetics, are already the object of considerable effort in their esthetic design. Along with being large enough to easily carry reservoir, plumbing and pump components, the addition of water flow to such gates would be particularly attractive.

Although the preferred embodiment is a gravity flow implementation, for the soothing acoustics produced, the flow surface could be sealed and channeled such that the pump could achieve a variety of flow characteristics. Many variations will occur to a skilled designer

The inventor also contemplates that a variety of textures and patterns could be employed on the flow surface for esthetic effects. In fact the inventor has found that texturing is highly preferable to non-textured flow surfaces for both visual and acoustic effect.

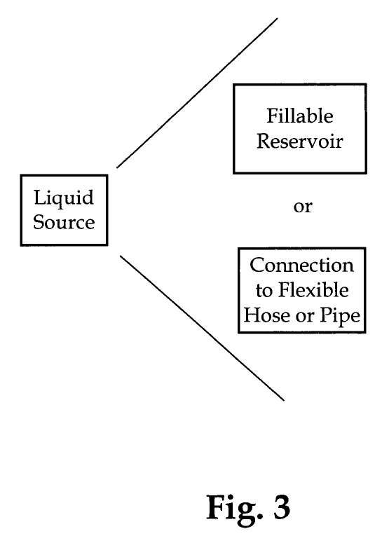

A variety of implementations are possible, particularly for a large entry gate. As shown in FIG. 3, the liquid source could be a reservoir that is periodically filled, either manually or automatically. Since the liquid is preferably recirculating, a fillable reservoir would be quite practical from a maintenance standpoint, particularly if the flow surface was whole or partially sealed. Of course some acoustic effect would be lost if the surface is sealed, so a system where the barrier is connected by flexible hose or piping to main water supply is also possible. Such a system could have a level sensor in a reservoir, which opens a valve to the supply only as needed.

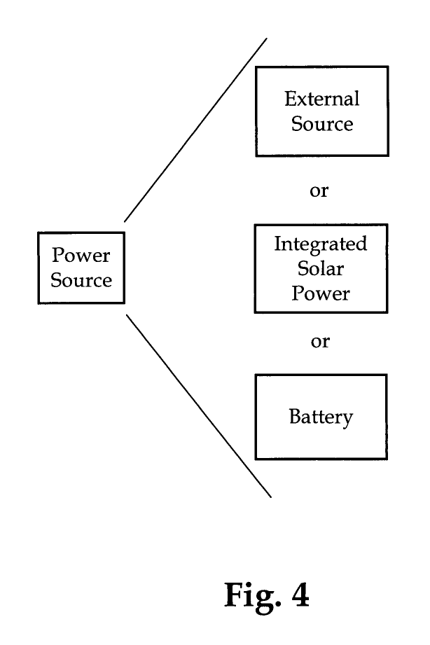

Powering the pump could be accomplished in a variety of ways as shown in FIG. 4. Wiring directly to an external power source using a take-up cabling harness is possible and such arrangements are known. The system could also be battery powered, preferably with a solar powered charging system.

I claim:

1. An aesthetic movable barrier comprising;
at least one motion degree of freedom, including a hinged or a sliding motion of the barrier,
a liquid source,
a pump,
a power source for the pump; and,
a plumbing system; wherein
liquid from the source is directed from a first portion plumbing system to flow across a portion of a face of the barrier and then captured by a second portion of the plumbing system for transport by pumping through a third portion of the plumbing system to the first portion, thereby providing an esthetic flow across the face of the movable barrier.

2. The barrier of claim 1 wherein the liquid source comprises at least one of;
a fillable reservoir; or,
a connection by flexible hose to an external supply.

3. The barrier of claim 1 wherein the power source comprises at least one of;
a connection to an external source,
an integrated solar power system; or,
a battery system.

4. The barrier of claim 1 wherein the flow surface is textured.

5. The barrier of claim 1 further comprising a lighting provision.

6. The barrier of claim 5 wherein the lighting provision is an OLED array forming at least part of the flow face.
